(19) United States
(12) Patent Application Publication
(10) Pub. No.: US 2016/0315304 A1
(43) Pub. Date: Oct. 27, 2016

(54) Encapsulated Fusible Interconnect

(71) Applicant: ATIEVA, INC., Menlo Park, CA (US)

(72) Inventor: Richard J. Biskup, Sunnyvale, CA (US)

(73) Assignee: ATIEVA, INC., Menlo Park, CA (US)

(21) Appl. No.: 14/692,557

(22) Filed: Apr. 21, 2015

(51) Int. Cl. H01M 2/20

(52) U.S. Cl. CPC H01M 2/206; H01M 2220/20

(57) ABSTRACT

A fusible battery interconnect is provided that is integral to a bus bar, thereby allowing rapid, cost effective, and highly reliable connections to be made between the bus bar and the batteries within a battery pack.

### FIELD OF THE INVENTION

The present invention relates generally to battery packs and, more particularly, to a battery pack bus bar interconnect system.

### BACKGROUND OF THE INVENTION

In response to the demands of consumers who are driven both by ever-escalating fuel prices and the dire consequences of global warming, the automobile industry is slowly starting to embrace the need for ultra-low emission, high efficiency cars. One of the most common approaches to achieving a low emission, high efficiency car is through the use of a hybrid drive train in which an internal combustion engine is combined with one or more electric motors. An alternate approach that is intended to reduce emissions even further while simultaneously decreasing drive train complexity is one in which the internal combustion engine is completely eliminated from the drive train, thus requiring that all propulsive power be provided by one or more electric motors. Regardless of the approach used to achieve lower emissions, in order to meet overall consumer expectations it is critical that the drive train maintains reasonable levels of performance, range, reliability, and cost.

In order to lower battery pack cost and thus the cost of an EV, it is critical to reduce both component cost and assembly time. An area of pack fabrication that has a large impact on assembly time, especially for large packs utilizing small form factor batteries, is the procedure used to connect the batteries together, where the batteries are typically grouped together into modules which are then interconnected within the pack to achieve the desired output power. Fuses, designed to mitigate the effects associated with a short circuit, may be integrated into the interconnects that are used to connect the batteries to the corresponding bus bars, integrated into the interconnects that are used to connect the individual battery pack modules together within the battery pack, or integrated into the interconnects that are used to couple the load to the battery pack. Due to the safety concerns associated with large battery packs, in many instances multiple fuses are located throughout the battery pack, for example both at the individual battery level and at the battery module level.

In a conventional pack, the high current interconnect that electrically connects each terminal of each battery to the corresponding bus bar is typically comprised of a wire, i.e., a wire bond. As noted above, fusing elements may be integrated into these wire bonds, for example as disclosed in U.S. Pat. No. 8,133,608.

Regardless of whether or not a wire bond includes a fusing element, the process of wire bonding is a very time consuming, and thus costly, process and one which may introduce reliability issues under certain manufacturing conditions. Accordingly, what is needed is a robust fusible interconnect that allows the battery pack to be quickly and efficiently assembled, thus lowering manufacturing time and cost. The present invention provides such a fusible interconnect design and manufacturing process.

### SUMMARY OF THE INVENTION

The present invention provides a battery interconnect, where the battery interconnect electrically couples a bus bar to a battery terminal, the battery interconnect comprising (i) a first end portion formed as an extension of the bus bar; (ii) a second end portion distal from the first end portion and configured to be attached to the battery terminal; (iii) a fusible interconnect electrically connecting the first end portion to the second end portion, where the battery interconnect and the bus bar are fabricated from a single piece of material and formed without material discontinuities between the bus bar and the battery interconnect; and (iv) an encapsulant, the encapsulant encapsulating the fusible interconnect, where the encapsulant is electrically insulative, and where the encapsulant is applied to the fusible interconnect prior to attaching the second end portion of the battery interconnect to the battery terminal. The encapsulant may be rigid or semi-rigid. The encapsulant may be comprised of plastic. The encapsulant may be injection molded onto the fusible interconnect. The battery interconnect may be shaped and/or placed under tension prior to being encapsulated.

In one aspect, the encapsulant may cover, or encapsulate, a region of the bus bar that is proximate to the first end portion of the battery interconnect and cover, or encapsulate, a region of the second end portion of the battery interconnect, where the encapsulant extends completely between the region of the bus bar and the region of the second end portion of the battery interconnect.

In another aspect, a region of the upper layer of the encapsulant, proximate to a section of the fusible interconnect, may be thinned. Other than for the thinned region, preferably the upper encapsulant layer is of a substantially uniform thickness.

In another aspect, a region of the lower layer of the encapsulant, proximate to a section of the fusible interconnect, may be thinned. Other than for the thinned region, preferably the lower encapsulant layer is of a substantially uniform thickness.

In another aspect, a region of the upper layer of the encapsulant and a region of the lower layer of the encapsulant, both proximate to a section of the fusible interconnect, may be thinned. Other than for the thinned region, preferably the upper encapsulant layer is of a substantially uniform thickness. Similarly, other than for the thinned region, preferably the lower encapsulant layer is of a substantially uniform thickness.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 is a schematic diagram of a battery pack with bus bars above and below the battery cells;

FIG. 2 is a schematic diagram of a battery pack with bus bars adjacent to the positive terminals of the battery cells;

FIG. 3 provides a top view of a portion of a battery assembly, and in particular of the bus bar connections to a single battery;

FIG. 4 provides a top view of the assembly shown in FIG. 3, with the inclusion of a fuse interconnect encapsulant;

FIG. 5 provides a side view of the fusible interconnect shown in FIGS. 3 and 4 after initial fabrication;

FIG. 6 provides a side view of the fusible interconnect shown in FIG. 5 after shaping;

FIG. 7 provides a side view of the fusible interconnect shown in FIG. 6 after encapsulation;

FIG. 8 provides a top view of a portion of a battery assembly similar to that shown in FIG. 4 except that a region of the encapsulation layer has been thinned;

FIG. 9 provides a cross-sectional view of the fusible interconnect shown in FIG. 8, where the thinned region is only on the upper surface of the encapsulation layer; and

FIG. 10 provides an alternate embodiment in which the encapsulation layer is thinned on either side of the interconnect.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps or calculations, these steps or calculations should not be limited by these terms, rather these terms are only used to distinguish one step or calculation from another. For example, a first calculation could be termed a second calculation, and, similarly, a first step could be termed a second step, without departing from the scope of this disclosure.

In the following text, the terms “battery”, “cell”, and “battery cell” may be used interchangeably and may refer to any of a variety of different battery configurations and chemistries. Typical battery chemistries include, but are not limited to, lithium ion, lithium ion polymer, nickel metal hydride, nickel cadmium, nickel hydrogen, nickel zinc, and silver zinc. The terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system.

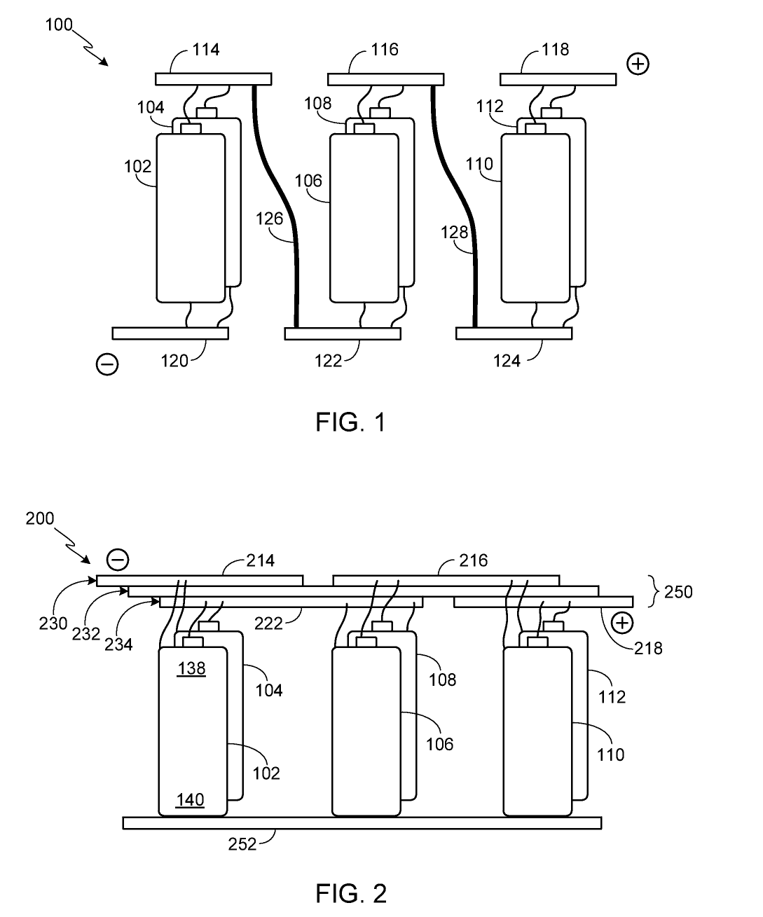

FIG. 1 illustrates an exemplary battery pack 100 illustrating a common battery pack configuration. As shown, battery pack 100 includes a first group of batteries 102 and 104 connected in parallel, a second group of batteries 106 and 108 connected in parallel, and a third group of batteries 110 and 112 connected in parallel. The first, second and third groups of batteries are connected in series. Bus bars 114, 116, 118, 120, 122, 124 are used to connect the batteries in this parallel and series arrangement. Each of the bus bars is coupled to the respective batteries with one or more interconnects. A relatively thick wire 126 couples the second bus bar 114 to the third bus bar 122, making a series connection between the first and second battery groups, while a second relatively thick wire 128 couples the fourth bus bar 116 to the fifth bus bar 124, making a series connection between the second and third battery groups. As a result, the first bus bar 120 is the negative terminal while the sixth bus bar 118 is the positive terminal for battery pack 100.

The use of bus bars at both ends of the batteries as illustrated in FIG. 1 requires a relatively complex manufacturing process in order to (i) attach the battery interconnects between the battery end surfaces and the bus bars, and (ii) attach the wires (e.g., wires 126 and 128) that couple the upper bus bars to the lower bus bars. Wires 126 and 128 are also problematic in the sense that they can introduce parasitic resistance into the current path, which in turn can introduce a voltage drop under high current drain conditions. Additionally this configuration prevents, or at least limits, the ability to efficiently remove battery pack heat by affixing a heat sink to a battery end surface.

FIG. 2 illustrates a battery pack 200 utilizing an alternate battery pack configuration in which all the bus bars are proximate to one end of the battery pack, thus enabling efficient heat removal from the other end of the battery pack. Furthermore, by locating bus bars 214, 216, 218 and 222 proximate to one end of the batteries, fewer bus bars are required than in battery pack 100. The relatively thick wires 126 and 128 from the upper bus bars to the lower bus bars are also eliminated in the embodiment shown in FIG. 2.

Access to both the positive and negative terminals in battery pack 200 is at one end of the cells, i.e., at the top end of the cells, where the bus bars are coupled to the positive and negative terminals using battery interconnects. As in the prior arrangement, the first group of batteries 102 and 104 are connected in parallel, the second group of batteries 106 and 108 are connected in parallel, and the third group of batteries 110 and 112 are connected in parallel. The first, second and third groups of batteries are connected in series. Bus bars 214, 216, 218, 222 are used to couple the batteries in this parallel and series arrangement. Specifically, starting with the negative terminal of battery pack 200, a first bus bar 214 is connected to the negative terminals of the first group of batteries 102 and 104 while a second bus bar 222 is connected to the positive terminals of the same group of batteries 102 and 104, both at the top end portion 138 of each of the batteries. The first and second bus bars 214 and 222 couple the first group of batteries 102 and 104 in parallel. Similarly, the second bus bar 222 and the third bus bar 216 couple the second group of batteries 106 and 108 in parallel, while the third bus bar 216 and the fourth bus bar 218 couple the third group of batteries 110 and 112 in parallel. Series connections between battery groups are formed by the bus bars, specifically the second bus bar 222 connects the positive terminals of the first group of batteries 102 and 104 to the negative terminals of the second group of batteries 106 and 108; and the third bus bar 216 connects the positive terminals of the second group of batteries 106 and 108 to the negative terminals of the third group of batteries 110 and 112. The fourth bus bar 218 is the positive terminal of the battery pack 200.

In battery pack 200 the bus bars are arranged in a layer stack 250. In this stacking arrangement first bus bar 214 and third bus bar 216, which are separated by an air gap or other electrical insulator to prevent short circuiting, are placed in a first layer 230. Similarly, second bus bar 222 and fourth bus bar 218, which are also separated by a gap or insulator, are placed in a third layer 234. Disposed between layers 230 and 234 is an electrically insulating layer 232. To simplify fabrication, the layer stack may be formed using layers of a circuit board, e.g., with the bus bars made of (or on) copper layers or other suitable conductive metal (such as aluminum) and the insulating layer made of resin impregnated fiberglass or other suitable electrically insulating material. It should be understood that layer stack 250 is simply an exemplary stack and that alternate bus bar arrangements may be used.

In a preferred embodiment, and as shown in the figures, the batteries have a projecting nub as a positive terminal at the top end of the battery and a can or casing that serves as the negative battery terminal. The batteries are preferably cylindrically shaped with a flat bottom surface. Typically a portion of the negative terminal is located at the top end of the cell, for example due to a casing crimp which is formed when the casing is sealed around the contents of the battery. This crimp or other portion of the negative terminal at the top end of the battery provides physical and electrical access to the battery's negative terminal. The crimp is spaced apart from the peripheral sides of the projecting nub through a gap that may or may not be filled with an insulator.

Preferably in a battery pack such as battery pack 200 in which the battery connections are made at one end of the cells (e.g., end portions 138), a heat sink 252 is thermally coupled to the opposite end portions 140 of each of the batteries. The heat sink may be finned or utilize air or liquid coolant passages. In some embodiments, a fan provides air flow across a surface of heat sink 252. In at least one embodiment, the heat sink is attached or affixed to the bottom of a battery holder. The co-planar arrangement of the batteries provides a relatively flat surface to attach a heat sink and in some embodiments the battery cells are designed to cool efficiently through the bottom of the cells, e.g., 18650 lithium ion batteries.

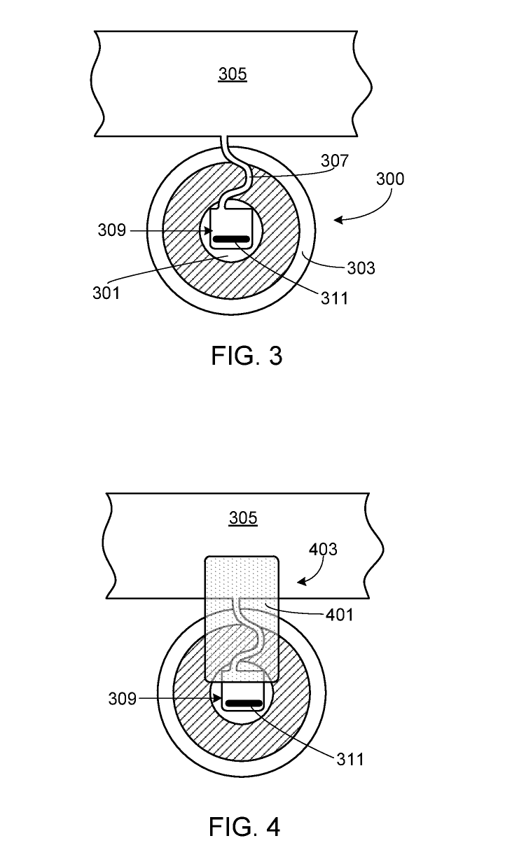

FIG. 3 provides a top view of a portion of a battery pack, and more specifically of a single battery 301, similar in design to those shown in FIGS. 1 and 2, and a portion of a bus bar. Battery 300 includes a raised nub 301 that serves as one terminal of the battery, typically the positive terminal, while the top edge 303 of the battery 301 serves as the second terminal of the battery, typically the negative terminal. In a typical 18650 form factor battery, edge 303 is a part of the battery casing which is crimped to hold the cap assembly and the electrode assembly in place within the casing. It will be appreciated that the invention described in detail below is equally applicable to other battery configurations, for example non-cylindrical batteries.

In the illustration a single bus bar 305 is shown, where bus bar 305 is electrically connected to terminal 301 via a fusible interconnect 307. It should be understood that fusible interconnect 307 is equally applicable to use with terminal 303. Preferably interconnect 307 is fabricated in the same manufacturing process used to fabricate the corresponding bus bar. Alternately the fusible interconnect may be formed in a secondary process. Once the contact tab 309 of fusible interconnect 307 is properly positioned relative to the corresponding battery terminal, the contact tab is attached to the terminal via joint 311. Preferably joint 311 is formed by laser welding the contact tab in place, although it should be understood that other attachment techniques may be used such as e-beam welding, resistance welding, ultrasonic welding, thermocompression bonding, thermosonic bonding, etc.

The fusible interconnect 307 and bus bar 305 are preferably fabricated from a single piece of material and formed such that there are no material discontinuities between the bus bar and the interconnect, i.e., interconnect 307 maintains material continuity with bus bar 305. Fusible interconnect 307 is designed to pass the expected current for its intended application, e.g., a specific battery pack configuration, but to fuse during an overcurrent condition. Overcurrent conditions typically occur during a short circuit.

Due to the relatively delicate nature of fusible interconnect 307 and the goal of utilizing a high speed manufacturing process that achieves high reliability, in accordance with at least one embodiment of the invention the fusible interconnect is encapsulated with a rigid, or semi-rigid, electrically insulating material. This aspect of the invention is shown in FIG. 4 in which fusible interconnect 307 is encapsulated. In order to provide the fullest benefit to the manufacturing process, encapsulant 401 is applied to the bus bar fusible interconnects after bus bar fabrication but prior to the battery connection process. Encapsulant 401 is preferably fabricated from plastic (e.g., nylon, polystyrene, acetal, polypropylene, polyethylene, polycarbonate, acrylonitrile butadiene styrene (ABS), etc.) and preferably applied by an injection molding process. In order to fully protect the fusible interconnect, preferably encapsulant 401 extends between, and covers (or encapsulates), a portion of the bus bar body portion 403 and a portion of contact tab 309 of the fusible interconnect 307.

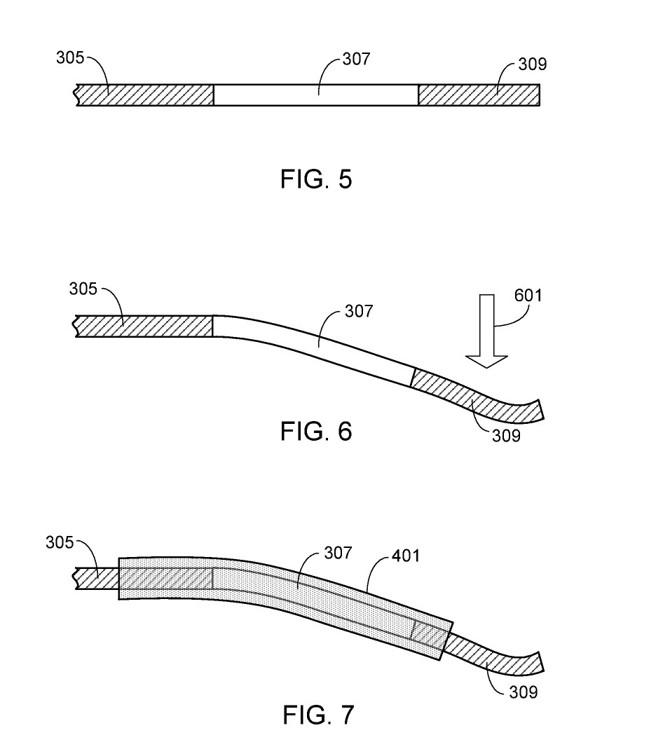

In one embodiment, the fusible interconnect is shaped, e.g., placed under tension, prior to being encapsulated. This aspect of the invention is shown in FIGS. 5-7. FIG. 5 provides a side view of interconnect 307 after initial fabrication; FIG. 6 provides a side view of interconnect 307 after shaping; and FIG. 7 provides a side view of interconnect 307 after encapsulation. Depending upon the material comprising bus bar 305, in some embodiments it is necessary to apply a tensioning force in direction 601 during the encapsulation process. It should be understood that while fusible interconnect 307 along with bus bar 305 and contact tab 405 are preferably fabricated as a single piece, to provide clarity in the figures bus bar 305, interconnect 307 and contact tab 309 are shown with different shading. Preferably the layer of encapsulant that is applied to the fusible interconnect is of a substantially uniform thickness, or at least the upper and/or lower layers that cover the upper and lower surfaces, respectively, of the fusible interconnect are of a substantially uniform thickness.

While encapsulant layer 401 protects the fusible interconnect and aids in the prevention of damage that could occur during the interconnect coupling and battery pack assembly process, in some embodiments it is preferable to reduce the encapsulation layer directly adjacent to a portion of the fusible interconnect. Reducing encapsulant thickness serves several purposes. First, by minimizing the encapsulant in a specific region, there is less risk that the encapsulation material may alter the time it takes for the fuse to blow when an overcurrent event occurs. Second, by reducing the encapsulation thickness in a specific region, the interconnect can be tailored to fuse in a specific location. Third, encapsulation thinning can be used to direct the flow of debris that occurs when the fuse blows. Preferably the encapsulant is thinned during the encapsulation process, for example during an encapsulation molding process (e.g., injection molding), although the encapsulant can also be thinned after it has been applied to the interconnect. Except for the thinned region, preferably the layer of encapsulant that is applied to the fusible interconnect is of a substantially uniform thickness, or at least the upper and/or lower encapsulant layers are of a substantially uniform thickness other than for the thinned region(s).

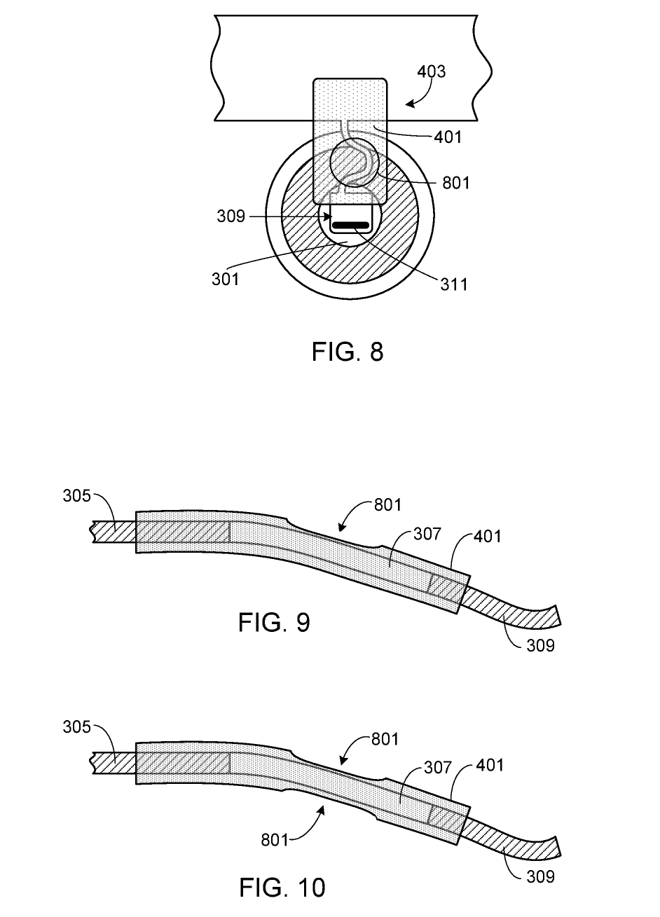

FIG. 8 provides a view of a portion of a battery assembly similar to that shown in FIG. 4 except that a region 801 of encapsulation layer 401 has been thinned. Preferably thinning is accomplished during the encapsulant molding process, although other well-known techniques may be used to reduce the thickness of the encapsulant in a specific region. FIG. 9 provides a side view of the fusible interconnect shown in FIG. 8, where thinned region 801 is only on the upper surface of the encapsulation layer. FIG. 10 provides an alternate embodiment in which the encapsulation layer is thinned on both sides of the interconnect.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

1. A battery interconnect, wherein said battery interconnect electrically couples a battery terminal of a battery to a bus bar, said battery interconnect comprising:
a first end portion formed as an extension of said bus bar;
a second end portion distal from said first end portion and configured to be attached to said battery terminal;
a fusible interconnect electrically connecting said first end portion to said second end portion, wherein said battery interconnect and said bus bar are fabricated from a single piece of material and formed without material discontinuities between said bus bar and said battery interconnect; and
an encapsulant, said encapsulant encapsulating said fusible interconnect, wherein said encapsulant is electrically insulative, wherein said encapsulant is applied to said fusible interconnect prior to attaching said second end portion of said battery interconnect to said battery terminal, wherein a region of said encapsulant is thinned, and wherein said region of said encapsulant that is thinned is proximate to a section of said fusible interconnect.

2. The battery interconnect of claim 1, wherein said encapsulant is semi-rigid.

3. The battery interconnect of claim 1, wherein said encapsulant is rigid.

4. The battery interconnect of claim 1, wherein said encapsulant is comprised of a plastic material.

5. The battery interconnect of claim 1, wherein said encapsulant covers a region of said bus bar proximate to said first end portion of said battery interconnect, wherein said encapsulant covers a region of said second end portion of said battery interconnect, and wherein said encapsulant extends completely between said region of said bus bar and said region of said second end portion of said battery interconnect.

6. The battery interconnect of claim 1, wherein said encapsulant encapsulates a region of said bus bar proximate to said first end portion of said battery interconnect, wherein said encapsulant encapsulates a region of said second end portion of said battery interconnect, and wherein said encapsulant extends completely between said region of said bus bar and said region of said second end portion of said battery interconnect.

7. The battery interconnect of claim 1, wherein said battery interconnect is shaped prior to said fusible interconnect being encapsulated by said encapsulant.

8. The battery interconnect of claim 1, wherein said battery interconnect is placed under tension prior to said fusible interconnect being encapsulated by said encapsulant.

9. The battery interconnect of claim 1, wherein said region of said encapsulant that is thinned corresponds to an upper layer of said encapsulant.

10. The battery interconnect of claim 9, wherein said upper layer of said encapsulant is of a substantially uniform thickness except for said region.

11. The battery interconnect of claim 1, wherein said region of said encapsulant that is thinned corresponds to a lower layer of said encapsulant.

12. The battery interconnect of claim 11, wherein said lower layer of said encapsulant is of a substantially uniform thickness except for said region.

13. The battery interconnect of claim 1, wherein said region of said encapsulant that is thinned corresponds to a first thinned area of an upper layer of said encapsulant and to a second thinned area of a lower layer of said encapsulant.

14. The battery interconnect of claim 13, wherein said upper layer of said encapsulant is of a substantially uniform thickness except for said first thinned area.

15. The battery interconnect of claim 13, wherein said lower layer of said encapsulant is of a substantially uniform thickness except for said second thinned area.

16. The battery interconnect of claim 1, wherein said encapsulant is injection molded to said fusible interconnect.
